(19) United States
(12) Patent Application Publication
(10) Pub. No.: US 2016/0104362 A1
(43) Pub. Date: Apr. 14, 2016

(54) CABLE SIGNAL DETECTOR

(71) Applicant: Hitachi Metals, Ltd., Tokyo (JP)

(72) Inventors: Yohei SHIRAKAWA, Hitachi (JP); Koki HIRANO, Hitachinaka (JP); Yoshitake AGElSHI, Hitachi (JP)

(21) Appl. No.: 14/873,095

(22) Filed: Oct. 1, 2015

(30) Foreign Application Priority Data
Oct. 8, 2014 (JP) 2014-207269

(51) Int. Cl. G08B 21/18

(52) U.S. Cl. CPC G08B 21/182

(57) ABSTRACT

A cable signal detector for a connector at an end of a communication cable or for a relay connector connected with the connector includes a rectifier circuit that branches and extracts a portion of signal transmitted through the communication cable, rectifies the extracted signal into a DC signal and outputs the DC signal, a comparator that outputs a predetermined voltage signal if a voltage of the DC signal is not less than a preset threshold voltage, and a light-emitting circuit that emits light when the comparator outputs the predetermined voltage signal.

The present application is based on Japanese patent application No. 2014-207269 filed on Oct. 8, 2014, the entire contents of which are incorporated herein by reference.

### BACKGROUND OF THE INVENTION

1. Field of the Invention

The invention relates to a cable signal detector.

2. Description of the Related Art

In data centers etc., the connection of a communication cable such as a LAN (local area network) cable may be changed in accordance with layout change, displacement or addition of information communication device such as a server and a hub.

Some information communication devices are provided with a connection check lamp for checking the connection of communication cable.

Also, a device has been proposed in which the connection of the communication cable is monitored by detecting the insertion and removal of the connector of the communication cable (see e.g., JP-B-5274671).

### SUMMARY OF THE INVENTION

The conventional devices can only check the physical connection of the communication cable. Thus, it is not possible to check whether the communication is actually established through the communication cable.

The communication cable may be erroneously removed without noticing the establishment of communication. Thus, a failure may be caused which includes a service shutdown of the information communication device and a data corruption during transfer.

Where the connection of the communication cable is monitored as in JP-B-5274671, the communication cable needs a built-in monitoring signal line. Since a versatile communication cable is thus difficult to use therewith, the manufacturing cost may increase.

It is an object of the invention to provide a cable signal detector that allows the notification of the establishment of information communication therethrough so as to prevent the erroneous removal of the communication cable even if versatile communication cables are used.

(1) According to one embodiment of the invention, a cable signal detector for a connector at an end of a communication cable or for a relay connector connected with the connector comprises:

a rectifier circuit that branches and extracts a portion of signal transmitted through the communication cable, rectifies the extracted signal into a DC signal and outputs the DC signal;

a comparator that outputs a predetermined voltage signal if a voltage of the DC signal is not less than a preset threshold voltage; and

a light-emitting circuit that emits light when the comparator outputs the predetermined voltage signal.

In the above embodiment (1) of the invention, the following modifications and changes can be made.

(i) The cable signal detector further comprises a matching circuit for adjusting a level of the extracted signal.

(ii) The cable signal detector further comprises an amplifier circuit that amplifies the extracted signal into an amplified signal and outputs the amplified signal to the rectifier circuit.

### Effects of the Invention

According to an embodiment of the invention, a cable signal detector can be provided that allows the notification of the establishment of information communication therethrough so as to prevent the erroneous removal of the communication cable even if versatile communication cables are used.

### BRIEF DESCRIPTION OF THE DRAWINGS

Next, the present invention will be explained in more detail in conjunction with appended drawings, wherein:

FIG. 1A is a perspective view showing a cable signal detector in an embodiment of the present invention;

FIG. 1B is an illustration diagram showing the cable signal detector;

FIG. 2 is a circuit diagram showing an example of a matching circuit of in the embodiment;

FIG. 3 is a circuit diagram showing an example of an amplifier circuit in the embodiment;

FIG. 4 is a circuit diagram showing an example of a rectifier circuit in the embodiment; and

FIG. 5 is a circuit diagram showing an example of a light-emitting circuit in the embodiment.

### DETAILED DESCRIPTION OF THE PREFERRED EMBODIMENTS

An embodiment of the invention will be described below in conjunction with the appended drawings.

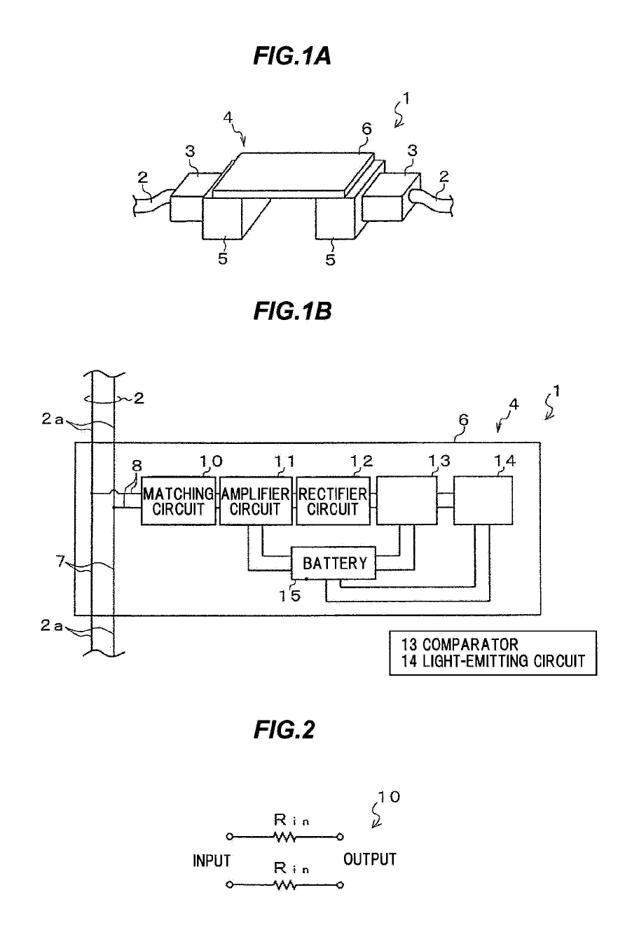

FIG. 1A is a perspective view showing a cable signal detector in an embodiment of the present invention and FIG. 1B is an illustration diagram showing the cable signal detector.

As shown in FIG. 1A and 1B, a cable signal detector 1 is provided in a relay connector 4 which is to be connected to a connector(s) 3 provided at an end of a communication cable 2.

The relay connector 4 is composed of two connectors 5 (e.g., jack connectors conforming to the RJ45 standard) respectively connected to the connectors 3 provided at ends of the communication cables 2, and a circuit board 6 mounting the both connectors 5. In FIG. 1B, the connectors 3 and 5 are omitted.

The cable signal detector 1 in the present embodiment is mounted on the circuit board 6 of the relay connector 4. However, it is not limited thereto and the cable signal detector 1 may be mounted on the connector 3 provided at an end of the communication cable 2.

In the present embodiment, the communication cable 2 having four pairs of signal lines 2a (eight in total) for transmitting differential signals is used. FIG. 1B shows only one of the four pairs of signal lines 2a. Main transmission paths 7 are formed on the circuit board 6 of the relay connector 4 so that the four pairs of signal lines 2a connected to the connector 5 are electrically connected to the four pairs of the other connector 5.

The cable signal detector 1 is composed of a matching circuit 10, an amplifier circuit 11, a rectifier circuit 12, a comparator 13 and a light-emitting circuit 14 which are connected sequentially.

The cable signal detector 1 is also provided with a battery 15 which provides power to the amplifier circuit 11, the comparator 13 and the light-emitting circuit 14. Alternatively, power may be externally supplied through a wire or wirelessly without providing the battery 15.

The matching circuit 10 is to provide impedance matching in a predetermined frequency band. In the present embodiment, since a portion of signal transmitted through the communication cable 2 is branched and extracted, the matching circuit 10 also serves to adjust the level of a signal extracted from the communication cable 2.

In detail, the matching circuit 10 is configured that, e.g., resistors Rin are respectively provided on two transmission paths, as shown in FIG. 2. Branch transmission paths 8 branched from a given pair of main transmission paths 7 are connected to the inputs of the matching circuit 10, and the outputs of the matching circuit 10 are connected to the inputs of the amplifier circuit 11. The matching circuit 10 can adjust the level of the signal extracted from the communication cable 2 by appropriately adjusting resistance values of the resistors Rin.

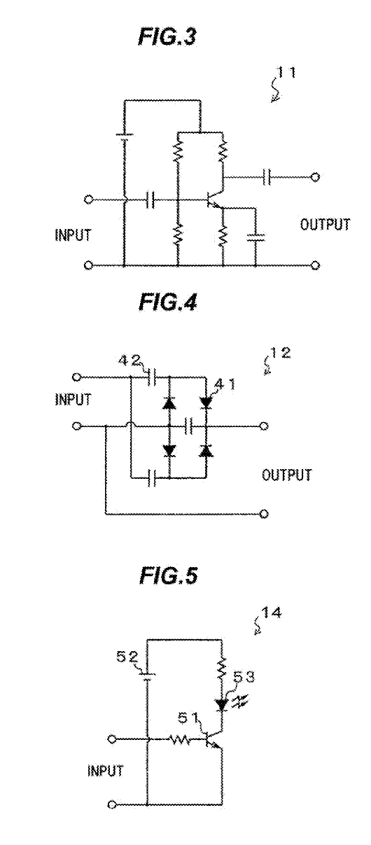

The amplifier circuit 11 is a circuit which amplifies the signal extracted from the communication cable 2 through the matching circuit 10 and outputs the amplified signal to the downstream rectifier circuit 12. As the amplifier circuit 11, it is possible to use, e.g., a so-called grounded emitter circuit as shown in FIG. 3. However, the specific configuration of the amplifier circuit 11 is not limited to that shown in FIG. 3. Although the amplifier circuit 11 is a single-stage configuration in the present embodiment, the amplifier circuit 11 may be a multistage configuration.

The rectifier circuit 12 rectifies the AC signal amplified by the amplifier circuit 11 into a DC signal and outputs the DC signal to the downstream comparator 13. As the rectifier circuit 12, it is possible to use a circuit having a combination of diode elements 41 and capacitive elements 42 as shown in FIG. 4. The specific configuration of the rectifier circuit 12 is not limited thereto and it is possible to use a well-known full-wave rectifier circuit or half-wave rectifier circuit.

The light-emitting circuit 14 is configured to emit light when the output of the comparator 13 is ON, i.e., when the comparator 13 is outputting a signal with a predetermined voltage.

As shown in FIG. 5, the light-emitting circuit 14 is provided with, e.g., a switching circuit using a transistor 51, and is configured that voltage input from the comparator 13 is applied between a base and an emitter of the transistor 51, and a DC power supply 52 and a light-emitting diode 53 are connected in series between a collector and the emitter. In the light-emitting circuit 14, electricity is conducted between the collector and the emitter of the transistor 51 when the output of the comparator 13 is ON, causing an electric current to flow through the light-emitting diode 53 which thus emits light. The specific configuration of the light-emitting circuit 14 is not limited thereto.

The cable signal detector 1 in the present embodiment has the comparator 13 between the rectifier circuit 12 and the light-emitting circuit 14.

The comparator 13 is a circuit which is turned on and outputs a DC signal with a predetermined voltage to the downstream light-emitting circuit 14 when the output voltage of the rectifier circuit 12 is not less than a preset threshold voltage (offset voltage).

Providing the comparator 13 allows a signal with a constant voltage to be output to the light-emitting circuit 14 even when the output voltage of the rectifier circuit 12 is small as long as offset voltage of the comparator 13 is set to a low level, and it is thereby possible to stably operate the light-emitting circuit 14.

Therefore, it is possible to reduce the level of the signal extracted from the communication cable 2 by increasing the resistance value of the resistors Rin of the matching circuit 10, which reduces reflection loss and insertion loss and thus suppresses deterioration in quality of the signal transmitted through the communication cable 2.

Meanwhile, strength of the signal transmitted through the communication cable 2 may be different depending on a communication device connected to the communication cable 2 or length of the communication cable 2. However, since the comparator 13 is provided, it is possible to stably operate the light-emitting circuit 14 even when the strength of the signal transmitted through the communication cable 2 is small.

Furthermore, since the output voltage of the rectifier circuit 12 can be reduced, it is possible to reduce output voltage of the amplifier circuit 11, to lower power consumption, and even to suppress deterioration in signal quality caused because the output signal of the amplifier circuit 11 enters the communication cable 2.

As described above, the cable signal detector 1 of the present embodiment is provided with the rectifier circuit 12 which branches and extracts a portion of signal transmitted through the communication cable 2, rectifies the extracted signal into a DC signal and outputs the DC signal, the comparator 13 which outputs a signal with a predetermined voltage when the output voltage of the rectifier circuit 12 is not less than a preset threshold voltage, and the light-emitting circuit 14 which emits light when the comparator 13 is outputting the signal with a predetermined voltage.

In such a configuration, since the light-emitting circuit 14 emits light during when signals are being transmitted through the communication cable 2, the telecommunication state is indicated and it is thereby possible to prevent removal of the communication cable 2 by mistake.

In addition, in the present embodiment, it is possible to use a universal communication cable as the communication cable 2 and the cost is therefore low since it is not necessary to provide a monitoring signal line, etc., in the communication cable 2, unlike the conventional technique.

Furthermore, in the present embodiment, since the comparator 13 is provided, it is possible to stably operate the light-emitting circuit 14 even when the output of the rectifier circuit 12 is small. As a result, it is possible to reduce the level of the signal extracted from the communication cable 2 or the output of the amplifier circuit 11, and it is thereby possible to suppress deterioration in quality of the signal transmitted through the communication cable 2.

The present invention is not intended to be limited to the embodiment, and it is obvious that the various kinds of changes can be made without departing from the gist of the invention.

What is claimed is:

1. A cable signal detector for a connector at an end of a communication cable or for a relay connector connected with the connector, comprising:
a rectifier circuit that branches and extracts a portion of signal transmitted through the communication cable, rectifies the extracted signal into a DC signal and outputs the DC signal;
a comparator that outputs a predetermined voltage signal if a voltage of the DC signal is not less than a preset threshold voltage; and
a light-emitting circuit that emits light when the comparator outputs the predetermined voltage signal.

2. The cable signal detector according to claim 1, further comprising a matching circuit for adjusting a level of the extracted signal.

3. The cable signal detector according to claim 1, further comprising an amplifier circuit that amplifies the extracted signal into an amplified signal and outputs the amplified signal to the rectifier circuit.

4. The cable signal detector according to claim 2, further comprising an amplifier circuit that amplifies the extracted signal into an amplified signal and outputs the amplified signal to the rectifier circuit.
